(19) United States
(12) Patent Application Publication
(10) Pub. No.: US 2011/0131077 A1
(43) Pub. Date: Jun. 2, 2011

(54) Context-Aware Recommendation Module Using Multiple Models

(75) Inventor: Ming Tan, Beijing (CN)

(73) Assignee: Microsoft Corporation, Redmond, WA (US)

(21) Appl. No.: 12/628,237

(22) Filed: Dec. 1, 2009

(51) Int. Cl. G06Q 30/00; G06Q 10/00

(52) U.S. Cl. 705/7.29; 705/347; 705/14.25

(57) ABSTRACT

A hybrid recommendation module leverages multiple sources of information to generate robust and personalized recommendations. The recommendation module provides an initial set of items by considering context information. The context information pertains to at least one environmental factor that has a bearing on the relevancy of recommended items (such as location, time, etc.). The recommendation module then produces a ranked set of items, selected from among the initial set of items, based on a user's past preference, using two or more recommendation models. The recommendation module can be applied in various environments, such as an environment which accommodates the use of mobile devices. The recommendation module can also be applied to various types of recommended items, such as establishment (e.g., store) items, product items, coupon items, etc. As to the last-mentioned type of items, the recommendation module can recommend coupon items using at least two modes of operation.

### BACKGROUND

Providers can supply information to users using different paradigms. In a well known search paradigm, a provider can supply information to a user which matches a query submitted by the user. This paradigm uses a pull-based approach, since the user actively “pulls” information from the provider in response to a targeted request for information. In another well known recommendation paradigm, a provider can independently supply information to a user which is deemed likely to pique the interests of the user. This paradigm uses a push-based approach, since the provider “pushes” information to the user without necessarily being prompted by the user to do so.

Different models exist for providing recommendations to users. In one such model, a provider can supply a recommendation based on features associated with a plurality of candidate items, vis-à-vis the assessed preferences of a particular user. This approach can be generally categorized as a content-based model because it focuses on the attributes of the items. In another model, a provider can supply a recommendation based on behavior exhibited by a population of users (such as explicit or implicit rating assessments made by the users). This approach can be generally categorized as a collaboration-based model because it relies on the contribution of multiple users. Still other techniques exist for providing recommendations. Different recommendation paradigms have respective strengths and weaknesses.

While successful, there is ample room for improvement in existing recommendation paradigms. For instance, many users now interact with information-providing networks using mobile computing devices, such as mobile telephones and the like. These types of environments introduce additional factors which complicate the task of generating relevant recommendations for users.

### SUMMARY

This disclosure sets forth a personalized recommendation module that uses a selector module to select an initial set of items based on context information. The context information pertains to at least one environmental factor which has a bearing on the relevancy of recommended items in an identified context. The recommendation module then uses a ranker module to produce at least one ranked set of items for a user based on at least one recommendation model, such as two or more recommendation models.

By virtue of the use of context information in combination with user preference information, the recommendation module can improve the relevance of its recommended items, especially in those environments in which users interact with a network using mobile devices (although the recommendation module can be used in any environment). By virtue of the use of plural models, the recommendation module can also provide a robust set of recommended items. For instance, the recommendation module yields relevant items even in those circumstances in which one or more recommendation models exhibit a high degree of potential noise, e.g., due to “cold start” scenarios and the like.

According to another illustrative feature, the ranking module can use different techniques to recommend items. In a combination technique, the ranker module can generate a ranked set of items by combining model scores provided by the plural recommendation models, e.g., by forming a weighted sum of the model scores.

According to another illustrative feature, the ranker module can use recommendation models which rely on one or more of: content-based information (pertaining to the attributes of items); collaboration-based information (pertaining to the behaviors exhibited by users with respect to the items); and friends-based information (pertaining to the relationships among users). Considered as a whole, the recommendation module can thus leverage multiple types of information to thereby improve the robustness in its set of recommended items forwarded to a user.

According to another illustrative feature, the recommendation module uses a portfolio management module to generate an output set of items based on the ranked set of items. The portfolio management module generates the output set of items on the basis of at least one portfolio management consideration. For example, the portfolio management module can modify the ranked set of items to improve the perceived variation associated with the items provided to a user.

According to another illustrative feature, the recommendation module can provide recommended items that refer to any type of objects. For example, the recommended items may pertain to establishments (e.g., stores), products (e.g., merchandise or services), coupons, etc., or any combination thereof.

According to another illustrative feature, the recommendation module can recommend coupon items using at least two modes of operation. In a first mode, the recommendation module first identifies a set of establishment items (e.g., store items) or the like. Then the recommendation module identifies a subset of those establishment items which have coupon items associated therewith. The recommendation module then forwards that subset of coupon items to the user. In a second mode, the recommendation module applies the above-described selector module, ranker module, and (optionally) portfolio management module to coupon items, rather than establishment items. In this approach, the ranker module applies recommendation models which focus on aspects of the coupon items per se, rather than providing preparatory analysis with respect to establishment items or the like.

The above functionality can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows of an overview of a system that includes a recommendation module.

FIG. 2 shows an overview of a processing environment that can be used to implement the system of FIG. 1.

FIG. 3 shows an illustrative ranker module that can be used in the recommendation module of FIG. 1.

FIG. 4 shows an alternative implementation of the recommendation module (of FIG. 1) that is adapted to process coupon items.

FIG. 5 shows another alternative implementation of the recommendation module that is adapted to process coupon items.

FIG. 6 is a flowchart that describes one illustrative manner of operation of the system of FIG. 1.

FIG. 7 is a flowchart that describes one illustrative manner of operation of the ranker module of FIG. 3.

FIG. 8 is a flowchart that describes one illustrative manner of operation of a start-up module employed by the ranker module of FIG. 3.

FIG. 9 is a flowchart that describes one illustrative manner of operation of the system of FIG. 1, as adapted to process coupon items according to a first mode of operation.

FIG. 10 is a flowchart that describes another illustrative manner of operation of the system of FIG. 1, as adapted to process coupon items according to a second mode of operation.

FIG. 11 shows illustrative processing functionality that can be used to implement any aspect of the features shown in the foregoing drawings.

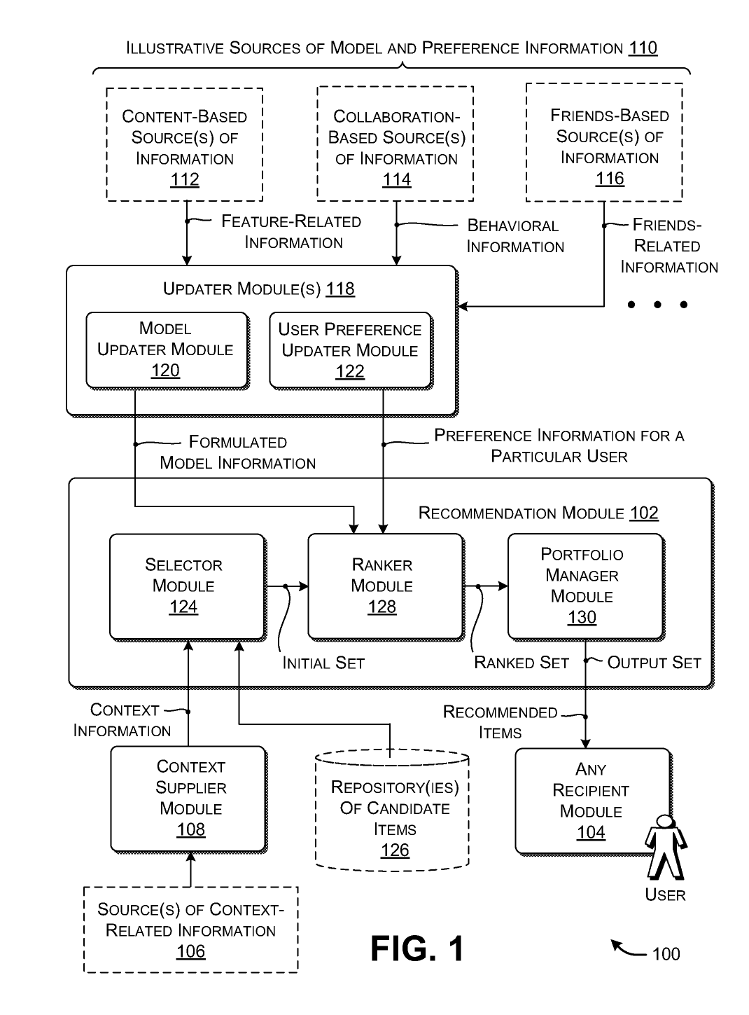

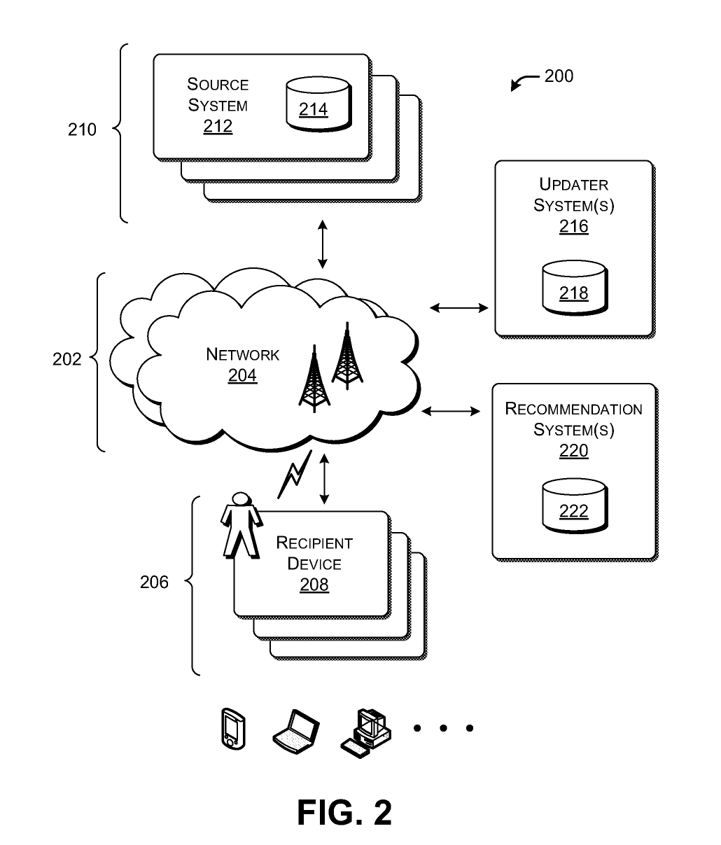

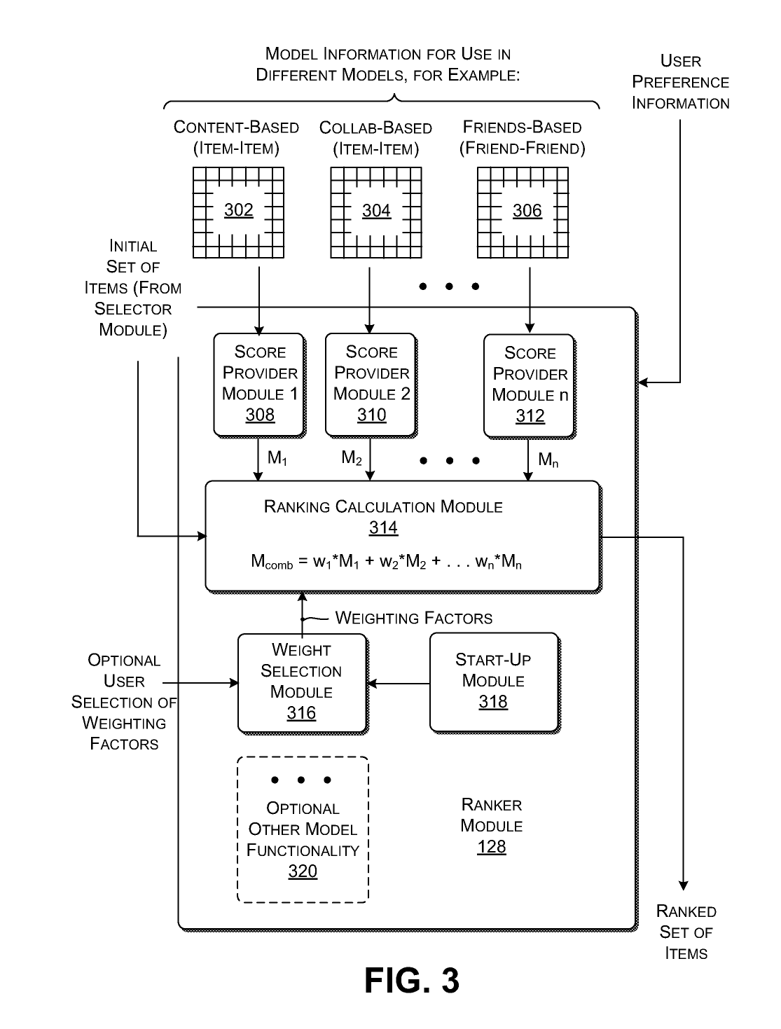

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure sets forth a hybrid recommendation module that recommends items based by leveraging plural types of information. In a first stage, the recommendation module takes context information into account. In a second stage, the recommendation module ranks items using at least one recommendation model.

Section A of this disclosure describes illustrative systems which implement the recommendation module. Section B describes the illustrative operation of the systems in flowchart form. And Section C describes illustrative data processing functionality that can be used to implement any aspect of the functionality described in Sections A and B.

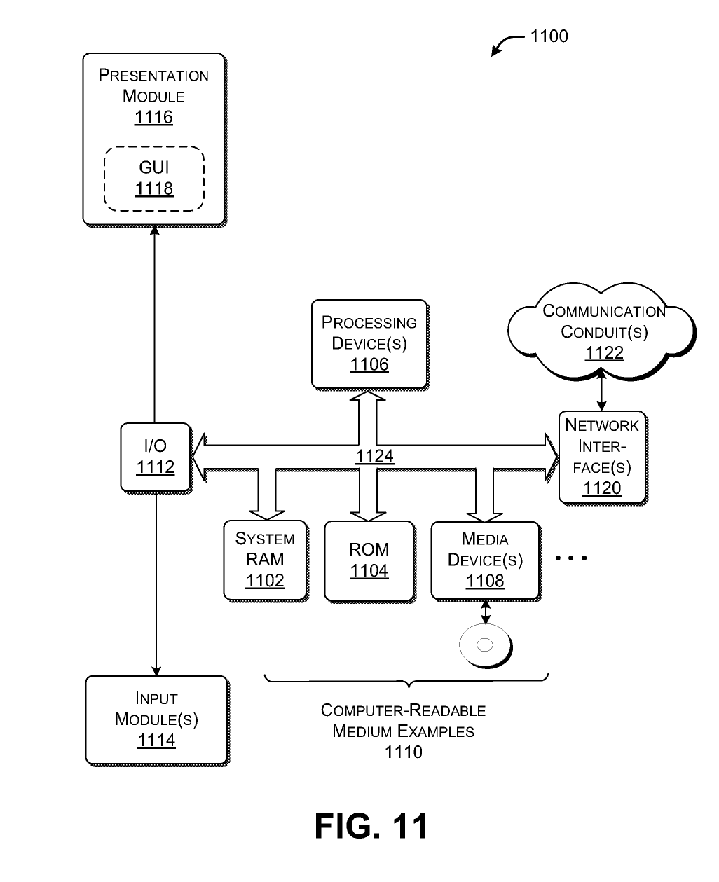

As a preliminary matter, some of the figures describe concepts in the context of one or more structural components, variously referred to as functionality, modules, features, elements, etc. The various components shown in the figures can be implemented in any manner. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component. FIG. 11, to be discussed in turn, provides additional details regarding one illustrative implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner.

As to terminology, the phrase “configured to” encompasses any way that any kind of functionality can be constructed to perform an identified operation. The term “logic” encompasses any functionality for performing a task. For instance, each operation illustrated in the flowcharts corresponds to a logic component for performing that operation. When implemented by a computing system, a logic component represents an electrical component that is a physical part of the computing system, however implemented. Finally, the terms “exemplary” or “illustrative” refer to one implementation among potentially many implementations.

A. Illustrative Systems

A.1. System Overview

FIG. 1 shows an overview of a system 100 which employs a recommendation module 102. The recommendation module 102 recommends items to a user. The user may consume (e.g., read) the recommended items at any recipient module 104. The recipient module 104 can be implemented by any type of electronic device. In one case, the recipient module 104 receives the items from the recommendation module 102 via wireless transmission. However, the recommendation module 102 can be used to provide items in any environment, including environments in which users receive items via stationary recipient modules.

The term “item” as used herein is intended to have broad connotation. An item refers to any abstract or tangible object that identifies any focus of interest. In one case, for example, an item can correspond to an establishment, such as a store, restaurant, etc. In another case, an item can correspond to a product or service of any type. In another case, an item can correspond to a coupon. The term item can refer to yet other objects.

The recommendation module 102 receives information from various sources. For example, the recommendation module 102 can receive information from one or more sources of context information 106. Context information has broad connotation as used herein. Generally, context information refers to at least one environmental factor which has a bearing on the relevancy of recommended items in an identified setting with respect to a particular user. Representative sources of context information 106 are identified below.

a) One source of context information can refer to functionality which supplies location information. The location information may identify a location at which a user will receive the recommended items (or some other identified location). This type of source can assess the location using various techniques. For example, this type of source can use GPS technology to assess the user's location. Alternatively, or in addition, this type of source can use triangulation technology to assess the user's location. Alternatively, or in addition, this type of source can assess the user's location based on information that the user manually supplies, and so on. No limitation is placed on the manner in which this type of source may assess the location of the user.

b) Another source of context information identifies temporal information, such as time information and/or date information. For example, this type of source identifies the time and/or date at which the items will be provided to a user.

c) Another source of context information identifies the type of recipient module 104 that the user is using to receive the items.

d) Another source of context information identifies a weather-related condition associated with a location at which the user will receive the items.

e) Another source of context information identifies behavior exhibited by the user. For example, this type of source may identify a type of computer-related application with which the user is currently interacting, or with which the user has recently interacted. Alternatively, or in addition, this type of source identifies content that that the user has recently supplied or with which the user is otherwise interacting. For example, this type of source may identify information that the user has recently typed or otherwise selected, e.g., in the course of typing a query, interacting with a network-accessible page, creating a document, etc.

f) Another source of context information may identify a mood (e.g., a state of mind) exhibited by the user at a current point in time. This type of source can infer the mood of the user based on the behavior exhibited by the user at the current point in time. Alternatively, or in addition, this type of source can allow the user to expressly identify his or her mood. For example, the user can indicate that she is feeling adventurous at the moment, which indicates that the user may be particularly receptive to items which span a diverse range of topics. Or the user may indicate that she is feeling conservative at the moment, which indicates that the user may desire items which narrowly focus on previously-expressed interests.

The sources of context information 106 may encompass yet other types of sources. Hence, the above list does not represent an exhaustive collection of such sources. Moreover, the recommendation module 102 can receive context information from any combination of sources. For example, the recommendation module 102 can receive context information from a source that supplies location information and a source that supplies temporal information, etc.

A context supplier module 108 performs the role of forwarding the context information from the various sources of context information 106 to the recommendation module 102.

The recommendation module 102 also receives information from various sources of model and preference information 110. As used herein, the term “preference information” refers to any data that reflects the interests of the users. As used herein, the term “model information” pertains to any data that plays a role in the operation one or more recommendation models. A recommendation model, in turn, refers to an algorithm used by the recommendation module 102 to assess the relevancy of items with respect to a particular recipient user. The preference information may at least partially overlap the model information, meaning that information that is used to reflect the interest of a user can also be used to build one or more recommendation models. Representative types of information sources are described below.

a) Content-based sources of information 112 provide information that pertains to the items per se. Such information is referred to as feature-related information herein. For example, assume that the items identify establishments or products. In this case, the content-based sources of information 112 may identify features or attributes associated with the items. For example, such a source may describe a camera by identifying its various physical properties, its performance, its cost, etc. The content-based sources of information 112 can be implemented in any manner, such as by one or more digital catalogues of information or the like.

b) Collaboration-based sources of information 114 provide information that relates to the preference-related behavior of users as it pertains to items. Such information is referred to as behavioral information herein. For example, such a source may maintain ratings that users expressly assign to items. For example, such a source may indicate that a user has assigned a rating of five stars to a particular item, or that a user has answered targeted questions about the item, and so on. Alternatively, or in addition, this type of source may indirectly identify the preferences of a user based on other behavior of the user. For example, such a source can conclude that the user has expressed an interest in a particular item because: i) the user has repeatedly clicked-on (or otherwise consumed) information regarding that item; or ii) the user has purchased or otherwise acquired the item; or iii) the user has designated this item as a favorite, and so on. Alternatively, or in addition, this type of source can provide functionality which “crawls” a network to discover salient information regarding the preferences of users who interact with the network. The collaboration-based sources of information 114 may encompass yet other kinds of techniques that convey the preferences of users. The collaboration-based sources 114 can be implemented in any manner, e.g., using rating tools, behavior-mining tools, web-crawling tools, etc.

c) Friends-based sources of information 116 provide information that conveys the relation among users. In one particular implementation, these sources describe the relation among friends. Such information is referred to as friends-related information herein. For example, such a source can identify, in either a direct or derived manner, the relation among friends based on information that users supply in an express manner, e.g., by defining contacts within a communication tool, a social networking service, etc. More specifically, such a source can identify both first-order friends and higher-order friends (for example, a second-order friend corresponds to a person that is a friend of a first-order friend). The friends-based sources of information 116 can be implemented in any manner, e.g., using one or more social networking services, one or more communication tools, and so on, in conjunction with appropriate relationship analysis tools.

In an alternative implementation, the friends-based sources of information 116 can be implemented as a more general user-based source of information. Such a source can infer the relation among users based on their behavior or some other evidence, e.g., without necessarily relying on information that is expressly supplied by the users. This type of user-based source is more encompassing than the friends-based sources of information 116 because it takes into account all users within an identified population of users.

The sources of model information 110 may encompass yet other sources. Hence, the above list does not represent an exhaustive collection of such sources. For example, the sources of model information 110 can encompass demographic information and other data regarding users.

One or more updater module(s) 118 receive and process the above described information from the various sources (112, 114, 116, etc.). The updater module 118 will be described in the singular below to simplify explanation. The updater module 118, in turn, can include two more component modules, such as a model updater module 120 and a user preference updater module 122. The model updater module 102 can periodically obtain model information from one or more sources of such information, and then provide this information to the recommendation module 102. The user preference updater module 122 can likewise obtain individual preference information from the above-described sources of information, and then provide this information to the recommendation module 102 for its use in generating recommendations for a particular user. In general, the updater module 118 ensures that the recommendation module 102 is supplied with current model information and preference information. The model updater module 120 and the user preference updater module 122 can use either a push or pull model (or some combination thereof) to perform their updating tasks.

In one case, the model updater module 120 also optionally formulates the model information into a form that is more readily usable by the recommendation module 102. For example, the model updater module 120 can formulate the feature-related information (from the content-based sources of information 112) into a table which provides item-to-item content-based information. The model updater module 120 can formulate the behavioral information (from the collaboration sources of information 114) into a table which provides item-to-item collaboration-based information. And the model updater module 120 can formulate the friends-related information (from the friends-based sources of information 116) into a table which provides friend-to-friend relationship information, and so on. Section A.2 (below) provides additional details regarding these illustrative types of tables. In general, these tables serve as inputs to respective recommendation models provided by the recommendation module 102.

The preference updater module 122 can also optionally maintain user histories which reflect the current behaviors (and hence current preferences) of respective users, e.g., as obtained from the collaboration-based sources of information 114 and elsewhere. As described above, the preference of any user can be gauged based on any prior behavior exhibited by the user, such as the express rating assessments made by the user, the browsing behavior exhibited by the user, the purchases made by the user, and so on.

The allocation of the functions described above is illustrative of one particular implementation. Other implementations can adopt other allocations. For example, various analysis functions attributed to the sources of model information 110 can instead be performed by the updater module 118 (and vice versa). For example, the model updater module 120 can determine the relation among a user l and a user m based on raw data provided by the friends-based sources of information 116, instead of receiving a conclusion as to this relationship from the friends-based sources of information 116.

The various features described so far (the sources of context information 106, the context supplier module 108, the content-based sources of information 112, the collaboration-based sources of information 114, the friends-based sources of information 116, and the updater module 118) can be implemented in any manner, such as by using various network-implemented server computer devices and associated databases. FIG. 2 (to be described shortly) provides additional details regarding one particular implementation of these features. Further, any of the features described above can be administered by any entity or combination of entities. For example, any of the features can be administered by the same entity which administers the recommendation module 102 itself, or a different entity.

In one mode of operation, at least parts of the features described above can operate in an offline mode of operation, whereas, by contrast, the recommendation module 102 operates in an online mode of operation. An offline mode of operation refers to processing that is independent of a user's real-time interaction with the system 100. For instance, the system 100 can periodically perform the functions described above in a batch mode using various backend server computer devices. An online mode of operation refers to processing that is generally responsive to the user's real time interaction with the system 100.

Some of the sources of information described above can provide information regarding the user, e.g., by collectively providing a behavioral history for each user who interacts with the system 100. In one implementation, any user may be permitted to expressly opt in or opt out of the collection of such information, and, indeed, to opt in or out of participation in the system 100 as a whole. Further, in one implementation, any user may be given full control over their personal information, allowing the user to control the manner in which the information is maintained (and deleted) within the system 100, the manner in which the information is used within the system 100, and so on. Further, the system 100 maintains appropriate security to address the risk of inadvertent disclosure of the personal information.

With the above discussion of the offline components of the system 100, the explanation now advances to a description of the recommendation module 102 itself, which, as said, can function in an online mode of operation. Various triggers can cause the recommendation module 102 to generate and provide items. For example, the recommendation module 102 can provide items in response to actions taken by a user (e.g., based on the user's browsing selections or the like). The recommendation module 102 can also provide items to the user in a manner which is largely independent of actions taken by the user. In both cases, the recommendation module 102 attempts to recommend items which match the assessed preferences of the user, e.g., as can be gleaned by the user's behavioral history as maintained by the user preference updater module 122.

According to one implementation, the recommendation module 102 uses a cascaded approach, in which the results of each component module serve as input to a “downstream” component module (if any). A first such component module is a selector module 124. The selector module 124 receives context information from the context suppler module 108. The selector module 124 also has access one or more repositories 126 of candidate items. For example, the repositories 126 may correspond to one or more stores which collectively provide a master list of candidate items that are available to recommend to users. In one particular implementation, the repositories 126 may represent items that are accessible via a network, such as the Internet. In this scenario, the repositories 126 may represent a dynamically changing set of candidate items. In one case, the selector module 124 can use various criteria to restrict the items in the repositories 126. For example, the selector module 124 can generate a master list of items which excludes or which otherwise penalizes items that the user has already acted upon. For example, if the goal of the recommendation module 102 is to recommend products, the selector module 124 can eliminate products that the user has previously purchased, or rated, or otherwise acted upon, etc. The user is presumed to already know about these items.

The selector module 124 uses the context information to cull an initial set of items from the master list of available candidate items. For example, suppose that the recommendation module 102 is applied in an environment which includes mobile recipient modules. The context information in this case may correspond to the location of a particular recipient module at a particular point in time. Further assume that a repository of candidate items identifies a master list of restaurants, e.g., within a particular state or region within a country. The selector module 124 can use the context information to select a subset of restaurants that are located within a certain distance of the user's present location. This is appropriate since it can be assumed that a user who is currently in city A at lunchtime is not interested in the restaurants located in city B. In another example, the selector module 124 can use location information to identify the direction in which the user appears to be traveling, e.g., along a highway. The selector module 124 can take this trajectory into account by suggesting appropriate restaurants, e.g., by focusing on restaurants that are ahead of the user and excluding restaurants that lie behind the user. Further, as explained above, the selector module 124 can provide an initial set of items based on plural pieces of context information, such any combination of location information, temporal information, mood information, etc.

In one implementation, the recommendation module 102 can allow each user to manually select the types of context information that the selector module 124 applies in forming the initial set of items (for that particular user). In addition, or alternatively, the selector module 124 can dynamically and automatically adjust the types of context information which it applies in forming the initial set of items. For example, users can apply feedback which indicates whether they are satisfied with the types of recommended items they are receiving from the recommendation module 102 (or this feedback can be automatically inferred). In response, the selector module 124 can automatically adjust the types of context information that it applies (or the weights assigned to different types of context information) in an attempt to improve the quality of its results.

A ranker module 128 receives the initial set of items from the selector module 124. The initial set of items can be considered as comprising a collection of candidate items. The ranker module 128 can process this initial set of items using one or more techniques associated with respective sub-modules, in conjunction with preference information. In general, the ranker module 128 assigns a score to each candidate item in the initial set of items for a user. This allows the ranker module 128 to rank the items in order of relevancy with respect to a particular user who will receive the items. That is, the ranker module 128 can assign the highest (or lowest) score to the item that is deemed to be most relevant.

Section A.2 (below) provides a detailed explanation of one implementation of the ranker module 128. By way of overview, in a combination technique, the ranker module 128 uses multiple recommendation models to generate multiple respective model scores associated with each candidate item (with respect to a particular recipient user). The ranker module 128 then combines the model scores to provide a combined score for each candidate item. The ranker module uses the combined scores associated with the candidate items to rank the candidate items, thus producing a ranked set of items.

The ranker module 128 can apply other ranking techniques. For example, instead of (or in addition to) the combination technique, the ranker module 128 can use one or more single-model techniques. In a single-model technique, the ranking module 128 generates a set of ranked items on the basis of a single recommendation model, such as a content-based model, a collaboration-based model, a friends-based model, or some other model. This means that the ranker module 128 can generate plural sets of ranked items for consideration at a later stage. However, to facilitate explanation, the ranker module 128 will be described as generating a single ranked set of items, unless otherwise noted.

An optional portfolio manager module 130 may modify the ranked set of items based on one or more portfolio management considerations to thereby produce an output set of items for delivery to a user. For example, the portfolio manager module 130 can apply a portfolio management consideration which attempts to improve the variation (e.g., “freshness”) in the items generated by the recommendation module 102. This feature reduces the chance that the recommendation module 102 will repeatedly generate a list of similar items, such as a list of similar restaurants. A user may perceive such a list as “stale,” and therefore uninteresting.

The portfolio manager module 130 can attempt to improve diversity in the output items through one or more techniques, such as by interjecting new items into the list of the top n recommended items, even though these new items may not otherwise have qualifying scores that warrant their inclusion in the top n items. Alternatively, or in addition, the portfolio manager module 130 can alter the order in which the top n recommended items are displayed, e.g., in one case, by randomizing the order of at least some of the items. Alternatively, or in addition, the portfolio manager module 130 can introduce popular items into the list of top items, even though these items may not otherwise entirely match the interests of a particular user.

As mentioned above, the ranker module 128 can optionally generate plural ranked lists of items, as produced using different ranking techniques (a content-based ranking technique, a collaboration-based ranking technique, a friends-based ranking technique, a combined-model ranking technique, and so on). In this case, the portfolio manager module 130 can optionally serve as a selection mechanism which selects from among different possible sets of ranked items produced by different ranking techniques. For example, the portfolio manager module 130 can exclusively select from among one ranked set of items generated based on a corresponding ranking technique. Alternatively, the portfolio manager module 130 can merge together the results of plural sets of ranked items based on any selection consideration or any combination of selection considerations. In one case, the portfolio manager module 130 can perform these selection and merging operations based on express configuration settings made by each user. Alternatively, or in addition, the portfolio manager module 130 can automatically infer an appropriate way to select from among different ranked sets of items, e.g., based on express and/or implicit feedback from the user.

The portfolio manager module 130 can also select an output set of items based on the characteristics of the output environment which will receive the items. For instance, assume that the recipient module 104 uses a two-dimensional display device to display the items. In this case, the portfolio manager module 130 can decide how to arrange the items on the display device, e.g., by deciding how many items to place at the top, bottom, left, right, and middle areas, etc. of the display device.

The recommendation module 102 can provide the output set of items to the user using any mechanism. For example, the recommendation module 102 can send the output set of items using wireless transmission, or using a hardwired network path, or by some other mechanism or combinations of mechanisms. The items can convey information in any manner, such as by providing textual information, graphic information, flash-content information, audio information, video information, and so on, or any combination thereof.

In summary, the recommendation module 102 can be said to combine multiple different types of information in generating an output set of items. For example, the recommendation module 102 can leverage context information, feature-related information (e.g., establishment or product attribute information), behavioral information (e.g., preference-related information), and social information (e.g., friends-related information), etc. This allows the recommendation module 102 to provide a robust set of recommended items. For instance, the recommendation module 102 can generate a relevant set of items that is likely to interest a particular user, even in those circumstances in which one or more of the recommendation models has a paucity of information from which to base its conclusions. Additional information regarding the resilience of the recommendation module 102 in different processing scenarios is provided below in Section A.2.

The recommendation module 102 can be modified in various ways. For example, the recommendation module 102 can optionally omit the selector module 124. In that case, the ranker module 128 processes the complete set of candidate items in the repositories 126, rather than a context-restricted subset of the candidate items. In another case, the ranker module 128 can be applied before the selector module 124. In this case, the selector module 124 can cull a subset of candidate items that have already been ranked by the ranker module 128. In another case, the recommendation module 102 can omit the portfolio manager module 130. Still other variations are possible.

FIG. 2 shows an overview of a processing environment 200 that can be used to implement the system 100 of FIG. 1. The processing environment 200 provides one or more networks 202, such as representative network 204. The networks 202 can include a local area network, a wide area network (such as the Internet), or any combination thereof. The networks 202 can be implemented using any combination of wired links, wireless links, routers, name servers, gateways, etc., as governed by any protocol or combination of protocols.

Users may interact with the networks 202 using respective recipient devices 206, such as representative recipient device 208. The recipient devices 206 may include mobile devices which communicate with the networks 202 via wireless transmission. Such recipient devices 206 include mobile telephones, personal digital assistant (PDA) devices, laptop computer devices, and so on. The recipient devices 206 can also include generally stationary devices, such as workstation computers, game consoles, set-top boxes, and so on. No limitation is placed on the types of devices which may interact with the networks 202.

One or more source systems 210 can implement the above-described sources of information of FIG. 1 (e.g., the sources of context information 106, the content-based sources of information 112, the collaboration-based sources of information 114, and the friends-based sources of information 116). One such source system corresponds to source system 212, which can be implemented by one or more server computer devices in conjunction with one or more database stores 214.

At least one updater system 216 can implement the updater module 118 of FIG. 1; one such system can be implemented by one or more server computer devices in conjunction with one or more database stores 218. Although not shown, at least one context supplier system can implement the context supplier module 108 of FIG. 1. Finally, at least one recommendation system 220 can implement the recommendation module 102 of FIG. 1; one such system can be implemented by one or more server computer devices in conjunction with one or more database stores 222.

In one case, the processing environment 200 can implement all of the functions of the recommendation module 102 using functionality provided at the recommendation system 220. In another case, the processing environment 200 can implement the functions of the recommendation module 102 using a combination of functionality provided in the recommendation system 220 and the recipient devices 206. For example, each recipient device can include thin client functionality which allows it to interact with the recommendation system 220. Still other implementations can be used to provide the functions described above.

A.2. Ranker Module

FIG. 3 shows one implementation of the ranker module 128 among other possible implementations. In particular, the ranker module 128 can perform multiple ranking techniques, as implemented by multiple respective sub-modules. FIG. 3 principally illustrates functionality which allows the ranker module 128 to perform a combined-score ranking technique. In this technique, the ranker module 128 receives the initial set of items provided by the selector module 124. The ranker module 128 computes a combined score for each of the candidate items in the initial set of items with respect to a particular user (and with respect to the preference information associated with the particular user). The ranker module 128 then orders the candidate items based on their respective combined scores, to thereby generate the ranked set of items.

To perform these functions, the ranker module 128 receives plural pieces of model information. In one representative and non-limiting case, the ranker module 128 receives (or otherwise has access to) a table which provides content-based information 302. For example, the content-based information 302 can identify items along a first axis and items along a second axis. Each element in the content-based information 302 can identify an assessed degree of similarity between two particular items identified by the axes, e.g., item j and item k. The degree of similarity indicates how close the features (or attributes) of item j are with respect to the features of item k. For example, two restaurants may be deemed similar if they both provide similar types of food, similar prices for food, similar ambiance, and so on.

The ranker module 128 also receives (or otherwise has access to) a table which provides collaboration-based information 304. Each element in the collaboration-based information 304 can identify an assessed degree of similarity between two particular items identified by its axes, e.g., item j and item k. Here, however, the degree of similarity is judged with respect to behavior exhibited by users with respect to these two items. Generally, two items may be deemed to be similar if they are assessed in a similar manner by a population of users, where such assessment can be explicit and/or implicit.

The ranker module 128 also receives (or otherwise has access to) a table which provides friends-based information 306. Each element in the friends-based information 306 can identify an assessed relationship among two particular users, e.g., user j and user k. As explained in Section A.1, the friends-based information 306 can originate, directly or indirectly, from relationship information specified by users in an express manner (e.g., by defining contacts). In another case, the system 100 of FIG. 1 can form a more general user-based table by inferring relations among an unrestricted population of users based on the behaviors of those users.

The ranker module 128 also receives (or otherwise has access to) preference information. The preference information reflects the interests of a particular user (for whom the recommendations are being generated).

To repeat, the explanation above corresponds to one representative implementation of the ranker module 128. Other implementations can omit one or more of types of model information described above. Alternatively, or in addition, other implementations can receive and process additional types of model information.

The ranker module 128 includes a collection of score provider modules (e.g., 308, 310, . . . 312) to generate respective model scores based on the different pieces of model information described above, in conjunction with the preference information. In doing so, the different score provider modules (308, 310, . . . 312) manifest different respective recommendation models.

For example, a first score provider module 308 can generate a model score M₁ for a particular candidate item i for a particular user based the content-based information 302. In one implementation, this score M₁ reflects the degree to which the candidate item i is deemed similar to other items that the user has highly rated or otherwise expressed an interest in, where similarity here reflects a likeness assessment within the domain of content-based similarity, e.g., pertaining to the features or attributes of the items.

A second score provider module 310 can generate a model score M₂ for a particular candidate item i based the collaboration-based information 304. In one implementation, this score M₂ reflects the degree to which the candidate item i is deemed similar to other items that the user has highly rated or otherwise expressed an interest in. For instance, the second score provider module 310 can score the candidate item i highly (or lowly) based on similar items that the user has rated highly (or lowly), e.g., using a similarity-weighted sum of ratings. In this case, the similarity reflects a likeness assessment within the domain of collaboration-based similarity, e.g., pertaining to rankings assigned to the items by a population of users.

A third score provider module 312 can generate a model score Mₙ for a particular candidate item i based the friends-based information 306. In one implementation, this score Mₙ reflects whether the candidate item i is somehow affiliated with a friend of the user. For example, a friend of the user may have expressed an interest in the candidate item i. If such a friend is a direct (first-order) friend of the user, the score provider module 312 can assign a relatively high score Mₙ to this candidate item i. If the friend is a higher-order friend (e.g., second or third order friend) of the user, then the score provider module 312 can provide an accordingly lower score Mₙ to the candidate item i. This manner of operation can be generalized for the situation in which the model information describes the relationships among users in a general population of users (without the expectation that these users have expressly identified their friends).

The ranker module 128 can provide yet other types of score provider modules.

In another implementation, some other component of the recommendation module 102 or system 100 as a whole can implement the score provider modules (308, 310, . . . 312). In this case, the ranker module 128 can directly receive the model scores.

In the combined ranking technique, a ranking calculation module 314 receives the model scores (M₁, M₂, . . . Mₙ) from the model score provider modules (308, 310, . . . 312) for each candidate item. Based thereon, the ranking calculation module 314 combines the model scores to generate a combined score M_{comb} for each candidate item, with respect to a particular user. For example, the ranking calculation module 314 can form a linear combination of the model scores. Weighting factors (e.g., w₁, w₂, . . . wₙ) may govern the respective influence of the different model scores in the linear combination. In one case, these weighting factors can be scaled such that they sum to 1.0. In other cases, the ranking calculation module 314 can use other types of functions (other than linear) to combine the model scores.

A weight selection module 316 supplies the weighting factors used by the ranking calculation module 314. The weight selection module 316 use different approaches to provide the weighting factors. In one case, the weight selection module 316 can allow each user to provide customized weighting factors. Through this functionality, each user can control the influence that each recommendation model has in producing the ranked set of items. In the extreme case, a user can assign a weighting factor of zero, which effectively removes all influence of a corresponding recommendation model.

In addition, or alternatively, the weight selection module 316 can dynamically and automatically adjust the weighting factors supplied to the ranking calculation module 314. For example, users can apply feedback which indicates whether they are satisfied with the types of recommended items they are receiving. Or this feedback can be inferred based on the behaviors of the users (e.g., depending on whether the users select recommended items, purchase recommended items, etc.). In response, the weight selection module 316 can automatically adjust the types of weighting factors that it applies to the ranking calculation module 314 in an attempt to improve the quality of its results.

The weight selection module 316 can also automatically adjust the weighting factors in response to interaction with a start-up module 318. The start-up module 318 identifies scenarios in which part of the model information that is supplied to the ranker module 128 suffers from a relatively high degree of noise, e.g., because not enough of this information has been collected or because the information is otherwise deficient. This may be the case, for example, when a new item is introduced into a master set of available candidate items. In this case, the collaboration-based sources of information 114 may provide insufficient information regarding the preferences of users with respect to this item, e.g., because most users have not encountered this item before.

In response, the weight selection module 316 in cooperation with the start-up module 318 can adjust the influence of certain recommendation models relative to other recommendation models. This has the effect of discounting the model information that has been assessed as noisy. For example, in the above-described start-up case, the weight selection module 316 in cooperation with the start-up module 318 can increase the weight applied to the content-based model score relative to the weight applied to the collaboration-based model score, effectively favoring the content-based model score.

More generally, consider a first case in which both the content-based information 302 and the collaboration-based information 304 yield model scores having positive correlation. Here, the ranking calculation module 314 can be controlled by taking the largest corresponding model score (setting the weighting factor for the smaller model score to 0). Consider next a second case in which both the content-based information 302 and the collaboration-based information 304 yield model scores having negative correlation. Here, the ranking calculation module 314 can be controlled by taking the smallest model score (setting the weighting factor for the larger model score to 0). Consider next a third case in which one of the content-based information 302 and the collaboration-based information 304 yields a negatively correlated model score, the other being positive. Here, the ranking calculation module 314 can be controlled by producing a new model score which is the average of the two original model scores.

The general notation “Optional Other Model Functionality” 320 in FIG. 3 indicates that the ranker module 128 can provide sub-modules which implement other ranking techniques, e.g., besides the above-described combined ranking technique. For example, each score provider module (308, 310, . . . 312) can act as a separate ranking sub-module that can be used to generate a ranked set of items (without the contribution of other score provider modules). (This can be alternatively achieved by setting appropriate weighting factors to zero.) Accordingly, the ranker module 128 can alternatively generate plural ranked sets of items; the portfolio manager module 130 can then be used to cull an output set of items from the plural sets of ranked items in the manner described above.

In addition, the ranker module 128 (or some other component in the recommendation module 102) can generate a combined (hybrid) model based on model information associated with two or more other models. For example, the ranker module 128 can create a new model based on feature-related information received from the content-based sources of information 112 and behavioral information from the collaboration-based sources of information 114. For example, the ranker module 128 can produce a new hybrid table, where each entry in the table is a weighted combination of corresponding entries in two or more source tables—e.g., a content-based table (content-based information 302) and an item-based table (collaboration-based information 304). Similarly, the ranker module 128 can create a hybrid table that includes the contribution of a friends-based table (friends-based information 306) and a user-based table that is based on a different source (compared to the friends-based table). The ranker module 128 can then rank items in the initial set of items using the hybrid model, in optional combination with one or more other recommendation models.

A.3. Coupon Processing Functionality

As described above, an item refers to any piece of information that identifies any focus of interest, corresponding to any abstract or tangible object. In one case, an item can refer to a coupon item. A coupon item refers to information that conveys a benefit to be conferred (or, more generally, an outcome to be achieved) upon the purchase or acquisition of a product, service, article, object, etc. For example, a coupon item may describe a discount that applies to the purchase of a product provided by a certain establishment. For example, such a coupon item may offer a recipient a certain percentage off the purchase price of a product or a rebate upon the purchase of the product. Or such a coupon may offer a free product with the purchase of one or more other products of like kind, and so on. A coupon item may also be characterized by various conditions regarding its use. For example, a coupon item's conditions may limit its use to certain locations, recipients, time spans, etc. No limitation is placed on the benefits conferred by a coupon item or the terms associated with the use of the coupon item.

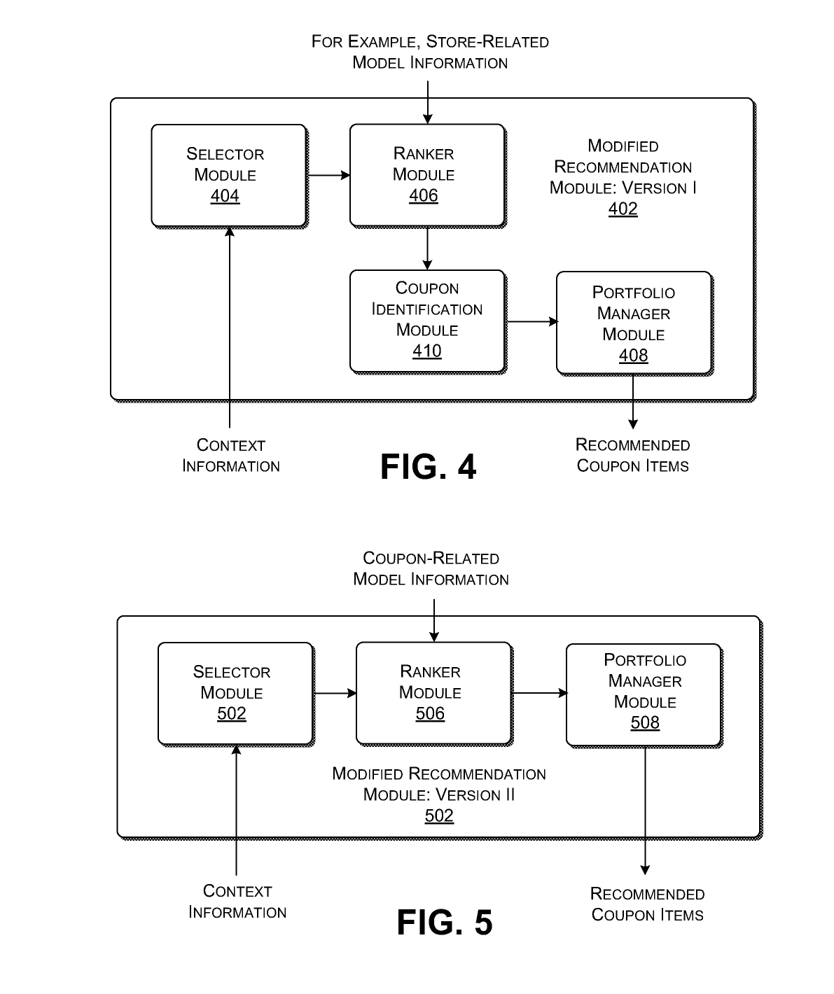

This section explains two ways in which the recommendation module 102 of FIG. 1 can be applied to process coupon items. Namely, FIG. 4 describes a recommendation module 402 which implements a first technique for processing coupon items. FIG. 5 describes a recommendation module 502 which implements a second technique for processing coupon items.

Beginning with FIG. 4, in this mode of operation, the recommendation module 402 operates, in part, in the same manner described above, e.g., using a selector module 404, a ranker module 406, and an optional portfolio manager module 408. Assume, in one example, that the master list of candidate items identifies particular stores that offer products or services. Alternatively, or in addition, the master list of candidate items may identify particular products and services. As before, the selector module 404 forms an initial set of items, as selected from such a master list of candidate items based on context information. The ranker module 406 then ranks the candidate items in the initial set of items, optionally based on multiple recommendation models. This operation generates a ranked set of items.

Now assume that a subset of the ranked set of items includes coupons associated therewith. Consider, for instance, the case in which the items in the ranked set of items correspond to stores. Some of the stores include coupons associated therewith. If this is the case, a coupon identification module 410 identifies the coupons associated with the stores in the ranked set of items. For example, the coupon identification module 410 can proceed down the list of items in the ranked set of items, selecting a prescribed number n of coupon items in the process. Thus, instead of providing a ranked set of store items (as described in Sections A.1 and A.2), the ranker module 406 in conjunction with the coupon identification module 410 now provide a ranked set of coupon items.

The portfolio manager module 408 can optionally process the list of coupon items in the manner described above, e.g., by taking steps to reduce the potential staleness in recommended coupon items. This may involve adding new coupon items, changing the order in which coupon items are presented, presenting popular coupon items, and so on.

The recommendation module 402 can be modified in various ways. For example, the coupon identification module 410 can be applied at different junctures in the cascaded processing performed by the recommendation module 402. For example, the coupon identification module 410 can be used to initially restrict the candidate items (e.g., stores) in the master list of candidate items to those candidate items that have coupons associated therewith. Or the coupon identification module 410 can be positioned between the selector module 404 and the ranker module 406, instead of “downstream” with respect to the ranker module 406 as shown in FIG. 4. Thus, when reference is made to identifying coupons associated with the ranked set of items, this does not necessarily imply that this identification operation occurs temporally subsequent to the functions performed by the ranker module 406.

In the mode of operation shown in FIG. 5, the recommendation module 502 again includes the main components shown in FIG. 1, namely a selector module 504, a ranker module 506, and an optional portfolio manager module 508. In this case, the recommendation module 502 omits the coupon identification module 410 used in FIG. 4. Instead, the recommendation module 502 places focus on the processing of coupon items, rather than first processing store items and then, as a follow-up, identifying coupon items.

For example, the selector module 504 selects an initial set of coupon items from a master list of coupon items (rather than establishment or product items). In this case, the selector module 504 can apply context information that has a particular bearing on the relevance of coupon items. For example, the context information can be used to select coupons items that can be redeemed within a region associated with the present location the recipient module 104.

As before, the ranker module 506 can apply multiple ranking models, where each ranking model processes a different type of model information. And as before, the types of model information may include any of: content-based information; collaboration-based information; and friends-based information, etc. But here the model information directly addresses aspects of the coupon items. For example, the content-based information can assess similarity among the coupon items based on features of the coupon items themselves. Illustrative features of the coupon items correspond to the type of benefits conferred by the coupon items, the type of products or services associated with the coupon items, the various terms associated with the coupon items, and so on. The collaboration-based information can assess similarity among coupon items based on the preferences of users with respect to the coupon items. For example, a user can be deemed to express an interest in a coupon item if the user has previously downloaded or otherwise acquired a coupon item, or has clicked on a coupon item, or has taken some other telltale action with respect to the coupon item. The friends-based information can provide the same information as before, e.g., by identifying the relationship among friends, or the relationship among a population of users in general. As a result of its processing, the ranker module 506 produces a ranked set of coupon items, rather than an intermediary set of ranked establishment items.

The portfolio manager module 508 can modify the ranked set of coupon items in the manner described above, e.g., by introducing “freshness” in the list of coupon items. This may involve adding new coupon items, changing the order in which coupon items are presented, presenting popular coupon items, and so on.

In one implementation, the coupon-centric processing of FIG. 5 may provide more relevant coupon items compared to the post-ranking coupon processing of FIG. 4. However, in other cases, the coupon-centric processing of FIG. 5 may fail to provide robust results because there is a paucity of information regarding coupon items; in this case, the post-ranking processing of FIG. 4 may provide a more satisfactory set of coupon items. In other cases, a recommendation module (not shown) can apply both types of coupon processing shown in FIGS. 4 and 5. Such a recommendation module can selectively combine the results provided by the two approaches based on the amount of noise in their respective input data sets.

B. Illustrative Manner of Operation of the Recommendation Module

The following section describes the manner of operation of the recommendation modules (102, 402, 502) set forth in Section A, according to illustrative and representative implementations. Since the principles underlying the operation of the recommendation modules (102, 402, 502) have already been described in Section A, certain operations will be addressed in summary fashion in this section.

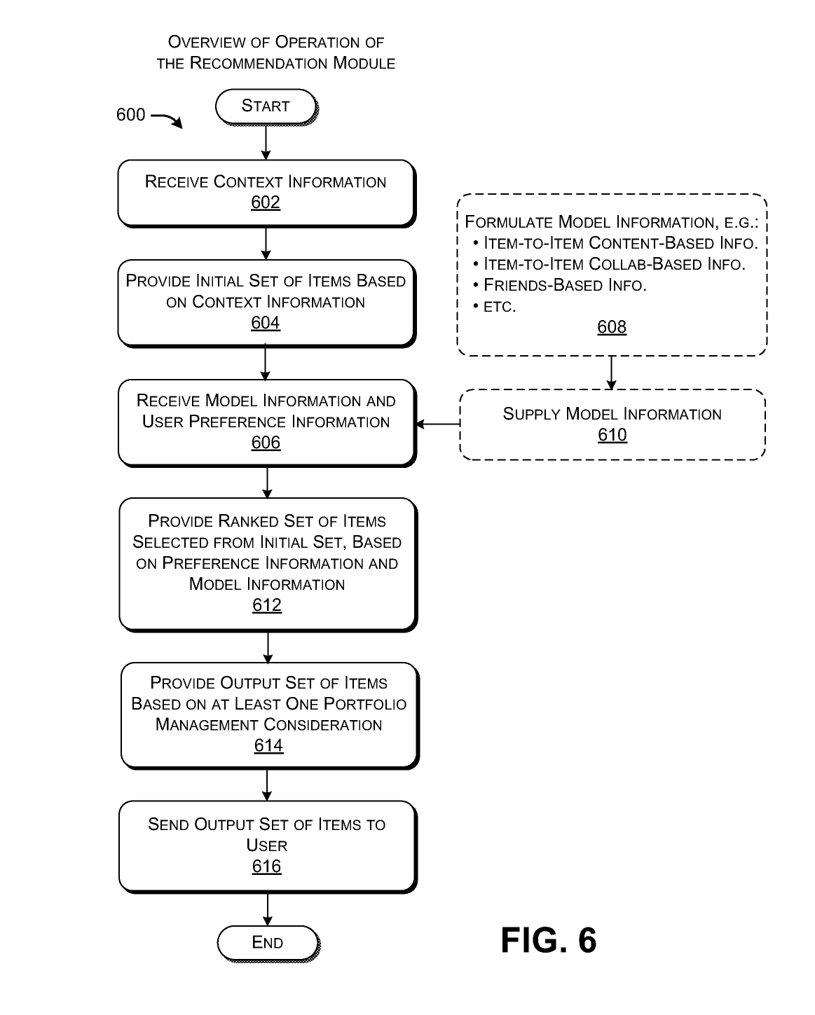

FIG. 6 is a procedure 600 that describes one illustrative manner of operation of the system 100 of FIG. 1, which includes the recommendation module 102.

In block 602, the recommendation module 102 receives context information.

In block 604, the selector module 124 generates an initial set of items based on the context information.

In block 606, the recommendation module 102 receives model information that originates from various sources, in conjunction with preference information. As indicated in blocks 608 and 610, one or more updater modules 118 can formulate and then supply the model information. In one implementation, the model information can include any of: content-based information; collaboration-based information; friends-based information, etc.

In block 612, the ranker module 128 provides at least one ranked set of items, selected from the initial set of items, optionally by using plural recommendation models.

In block 614, the portfolio manager module 130 optionally generates an output set of items by applying at least one portfolio management consideration.

In block 616, the recommendation module 102 sends the output set of recommendation items to the user, who may be operating the recipient module 104.

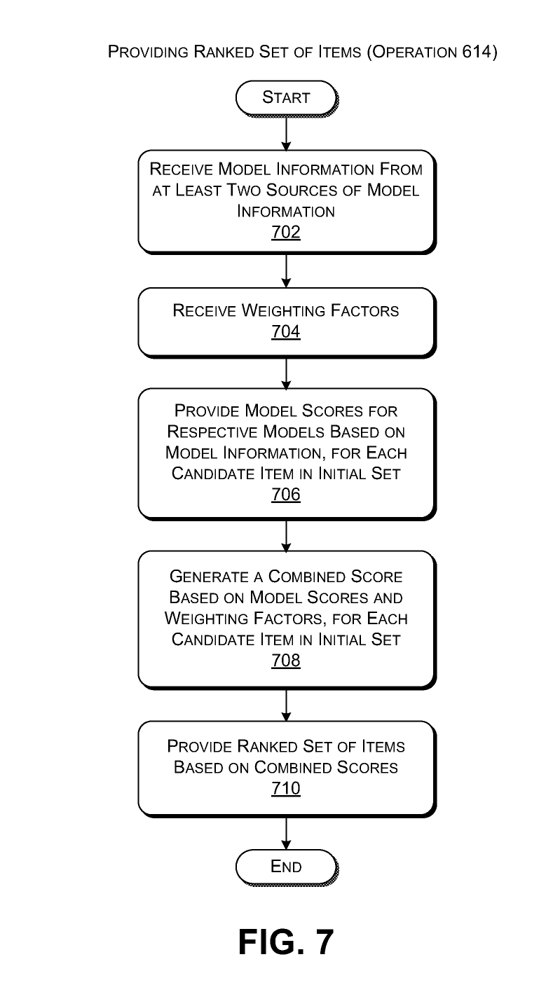

FIG. 7 is a procedure 614 that describes one illustrative manner of operation of the ranker module 128 of FIG. 3. In other words, the procedure 614 is an elaboration of block 614 introduced in FIG. 6. In this procedure 614, the ranker module 128 executes the combined ranking technique.

In block 702, the ranker module 128 receives model information from at least two sources of model information. As explained above, the model information can include any of: content-based information; collaboration-based information; friends-based information, etc.

In block 704, the ranker module 128 receives weighting factors.

In block 706, the ranker module 128 provides, for each candidate item, model scores using respective recommendation models.

In block 708, the ranker module 128 generates, for each candidate item, a combined score based on the model scores provided in block 706 and the weighting factors received in block 704.

In block 710, the ranker module 128 provides a ranked set of items on the basis of the combined scores provided in block 708.

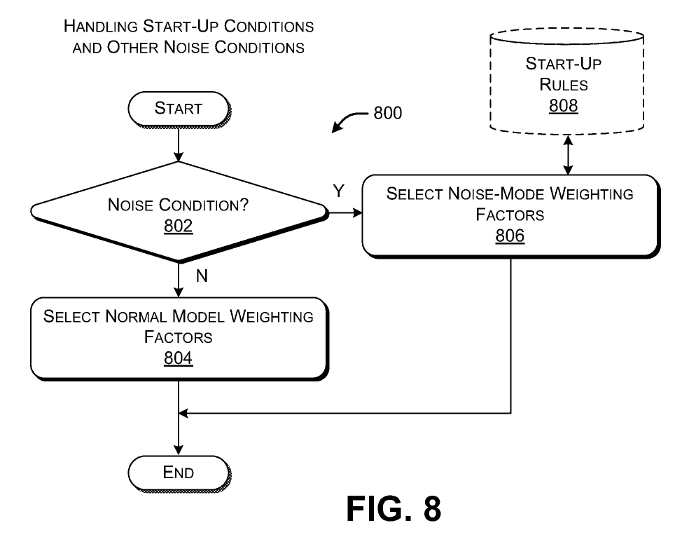

FIG. 8 is a procedure 800 that describes one illustrative manner of operation of the start-up module 318 and the weight selection module 316 of FIG. 3. This functionality will be collectively referred to as the start-up functionality for ease of reference below.

In block 802, the start-up functionality determines whether a noise condition prevails with respect to at least one part of the model information, such as the collaboration-based information. The noise condition affects the quality of information received from that part of the model information. For example, a noise condition may prevail due to the introduction of a new candidate item. That is, at this initial juncture, users may have lacked the ample opportunity to rank this item, thus making the collaboration-based information sparse.

If block 802 is answered in the negative, in block 804, the start-up functionality applies normal weighting factors (and/or other configuration settings) to the ranking calculation module 314. The normal weighting factors are normal insofar as they do not carry out particular corrections for noise conditions.

If block 802 is answered in the affirmative, in block 806, the start-up functionality can apply start-up weighting factors (and/or other configuration settings) to the ranking calculation module 314. The start-up weighting factors can have the effect of reducing the influence of non-robust parts of the model information. A database of start-up rules 808 can govern the manner in which the start-up functionality responds to different noise condition scenarios.

More generally stated, the start-up functionality operates by detecting that a noise condition exists which affects quality of information received from at least one source of model information. In response, the start-up functionality can adjust at least one configuration setting that counteracts the noise condition.

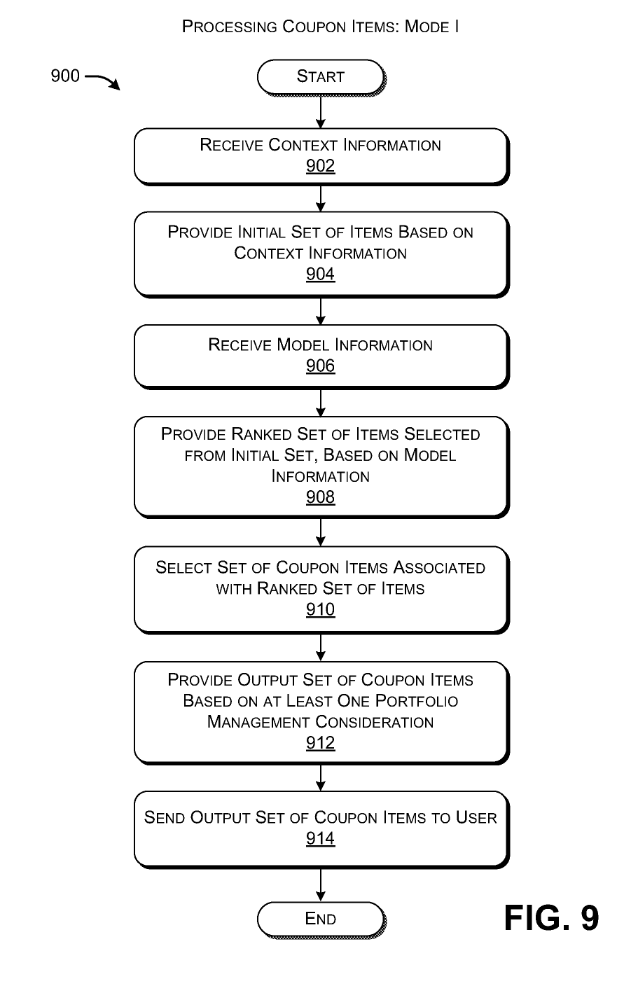

FIG. 9 is a procedure 900 that describes one illustrative manner of operation of the system 100 of FIG. 1, as adapted to process coupon items according to a first mode of operation. Reference is made below to the recommendation module 402 of FIG. 4, which operates based on the first mode of coupon processing.

In block 902, the recommendation module 402 receives context information.

In block 904, the selector module 404 generates an initial set of items. These items pertain to establishment (e.g., store) items, product items, or other type of items (other than coupon items).

In block 906, the recommendation module 402 receives model information and preference information.

In block 908, the ranker module 406 provides a ranked set of items, optionally using plural recommendation models.

In block 910, the coupon identification module 410 identifies the items in the ranked set of items which include coupons associated therewith. Through this process, the coupon identification module 410 generates a ranked set of coupon items, rather than a ranked list of store items or the like. The processing of block 910 can alternatively occur at other junctures in the processing of FIG. 9, such as after block 906.

In block 912, the portfolio manager module 408 optionally produces an output set of coupon items based on one or more portfolio management considerations.

In block 914, the portfolio manager module 408 sends the output set of coupon items to the recipient module 104

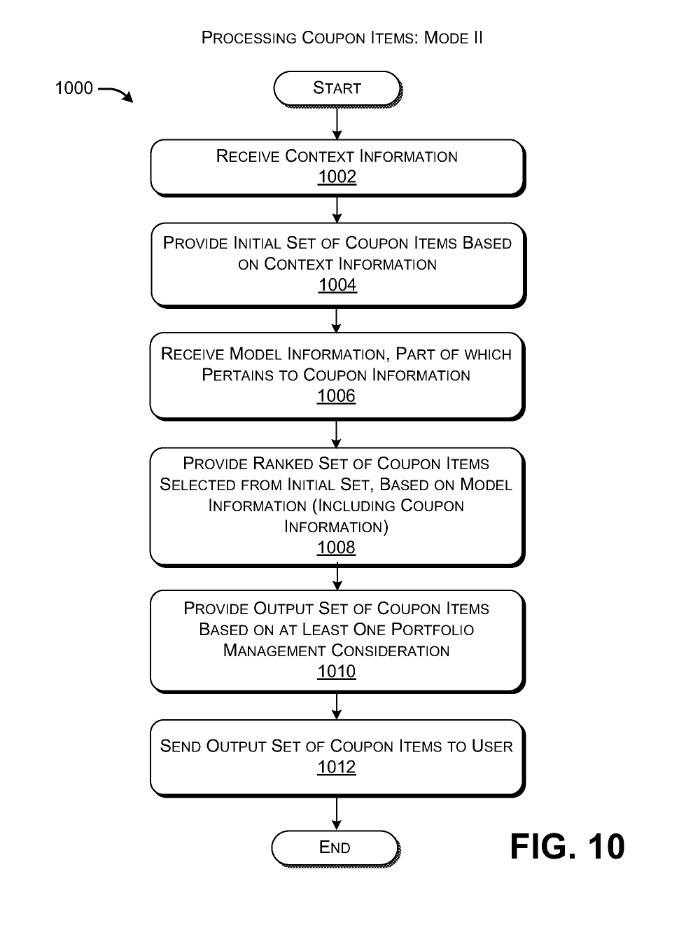

FIG. 10 is a procedure 1000 that describes another illustrative manner of operation of the system 100 of FIG. 1, as adapted to process coupon items according to a second mode of operation. Reference is made below to the recommendation module 502 of FIG. 5, which operates based on the second mode of coupon processing.

In block 1002, the recommendation module 502 receives context information.

In block 1004, the selector module 504 generates an initial set of coupon items.

In block 1006, the recommendation module 502 receives model information and preference information. Here, the model information particularly focuses on aspects of coupon items, rather than focusing, as a first pass, on aspects of establishment items or product items or the like.

In block 1008, the ranker module 506 provides a ranked set of coupon items, optionally using plural recommendation models. The ranker module 506 applies recommendation models (and associated model scores) which are based on the aspects of the coupon items.

In block 1010, the portfolio manager module 508 optionally produces an output set of coupon items based on one or more portfolio management considerations.

In block 1012, the portfolio manager module 508 sends the output set of coupon items to the recipient module 104.

C. Representative Processing Functionality

FIG. 11 sets forth illustrative electrical data processing functionality 1100 that can be used to implement any aspect of the functions described above. With reference to FIG. 2, for instance, the type of processing functionality 1100 shown in FIG. 11 can be used to implement any aspect of the recommendation system 220, the source systems 210, the updater system 216, and/or the recipient devices 206. In one case, the processing functionality 1100 may correspond to any type of computing device that includes one or more processing devices.

The processing functionality 1100 can include volatile and non-volatile memory, such as RAM 1102 and ROM 1104, as well as one or more processing devices 1106. The processing functionality 1100 also optionally includes various media devices 1108, such as a hard disk module, an optical disk module, and so forth. The processing functionality 1100 can perform various operations identified above when the processing device(s) 1106 executes instructions that are maintained by memory (e.g., RAM 1102, ROM 1104, or elsewhere). More generally, instructions and other information can be stored on any computer readable medium 1110, including, but not limited to, static memory storage devices, magnetic storage devices, optical storage devices, and so on. The term computer readable medium also encompasses plural storage devices. The term computer readable medium also encompasses signals transmitted from a first location to a second location, e.g., via wire, cable, wireless transmission, etc.

The processing functionality 1100 also includes an input/output module 1112 for receiving various inputs from a user (via input modules 1114), and for providing various outputs to the user (via output modules). One particular output mechanism may include a presentation module 1116 and an associated graphical user interface (GUI) 1118. The processing functionality 1100 can also include one or more network interfaces 1120 for exchanging data with other devices via one or more communication conduits 1122. One or more communication buses 1124 communicatively couple the above-described components together.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, implemented by a computer device, for recommending personalized items for a user, comprising:
receiving context information that originates from at least one source of context information;
receiving model information that originates from at least one source of model information;
providing an initial set of items based on the context information, the initial set of items having a plurality of candidate items;
providing a ranked set of items selected from among the initial set of items, based on the model information, together with user preference information, said providing using at least two recommendation models;
providing an output set of items selected on the basis of the ranked set of items, based on at least one portfolio management consideration; and
sending the output set of items to a recipient module for consumption by the user.

2. The method of claim 1, wherein at least one item in the output set of items corresponds to an establishment item which identifies an establishment.

3. The method of claim 1, wherein at least one item in the output set of items corresponds to a coupon item which identifies a coupon.

4. The method of claim 1, wherein the recipient module is a mobile device which receives the output set of items via wireless transmission.

5. The method of claim 1, wherein the context information includes at least one of:
temporal information which identifies at least one of a date or a time;
location information which identifies a present location of the user; or
mood information which identifies a current state of mind of the user.

6. The method of claim 1, wherein the model information originates from at least two sources of model information, said at least two sources of model information selected from among:
a content-based source of information which provides feature-related information regarding features of a plurality of items;
a collaboration-based source of information which provides behavioral information regarding user preferences associated with the plurality of items; and
a friends-based source of information which provides friends-related information regarding relationships among a plurality of users.

7. The method of claim 6, further comprising formulating and supplying the model information, said formulating comprising:
formulating item-to-item content-based information based on the feature-related information obtained from the content-based source of information;
formulating item-to-item collaboration information based on the behavioral information obtained from the collaboration-based source of information; and
formulating friend-to-friend information based on the friends-related information obtained from the friends-based source of information.

8. The method of claim 6, further comprising formulating and supplying hybrid model information that: combines feature-related information with behavioral information; and/or combines friends-related information with user-related information.

9. The method of claim 1, wherein said providing of the ranked set of items comprises:
providing for each candidate item in the initial set of items, at least two model scores based on said at least two respective recommendation models; and
generating, for each candidate item, a combined score based on said at least two model scores.

10. The method of claim 9, wherein said generating of the combined score comprises forming a weighted combination of said at least two model scores.

11. The method of claim 10, further comprising receiving weighting factors that govern the weighted combination.

12. The method of claim 1, further comprising:
detecting that a noise condition prevails which affects quality of information received from at least one source of model information; and
adjusting, based on said detecting, at least one configuration setting that counteracts said noise condition.

13. The method of claim 12, wherein said adjusting results in favoring a model score based on a content-based source of model information if the noise condition pertains to a start-up condition.

14. The method of claim 1, wherein said at least one portfolio management consideration relates to a degree of variation of items in the output set of items.

15. The method of claim 1, further comprising selecting a set of coupon items associated with the ranked set of items, wherein the output set of items that are sent to the user pertains to coupon items.

16. A computer-implemented recommendation module for recommending items for a user, comprising:
a selector module configured to receive context information from at least one source of context information, and, in response, to provide an initial set of items based on the context information;
a ranker module configured to receive model information from at least one source of model information, and, in response, to provide a ranked set of items on the basis of the initial set of items; and
a coupon identification module configured to select a set of coupon items associated with the ranked set of items.

17. The computer-implemented recommendation module of claim 16, wherein the ranker module is configured to provide the ranked set of items using plural recommendation models which generate respective model scores.

18. A computer readable medium for storing computer readable instructions, the computer readable instructions providing a recommendation module when executed by one or more processing devices, the computer readable instructions comprising:
logic configured to receive context information from at least one source of context information;
logic configured to receive model information from at least one source of model information, at least part of the model information pertaining to coupon information;
logic configured to provide an initial set of coupon items based on the context information, the initial set of coupon items having a plurality of candidate coupon items;
logic configured to provide a ranked set of coupon items selected from among the initial set of coupon items, based on the model information that pertains to the coupon information; and
logic configured to provide an output set of coupon items selected on the basis of the ranked set of coupon items.

19. The computer readable medium of claim 18, wherein said logic configured to provide a ranked set of coupon items comprises:
logic configured to provide at least two model scores associated with each candidate coupon item in the initial set of coupon items, based on at least two respective recommendation models; and
logic configured to generate a combined similarity score for each candidate item based on said at least two model scores.

20. The computer readable medium of claim 19, wherein said at least two model scores are based on coupon-related aspects of each candidate coupon item.
